(19) United States
(12) Patent Application Publication
(10) Pub. No.: US 2004/0263907 A1
(43) Pub. Date: Dec. 30, 2004

(54) Page processing apparatus and page processing method

(76) Inventor: Takuya Hiraki, Tokyo (JP)

Correspondence Address: RABIN & Berdo, PC, 1101 14TH STREET, NW, SUITE 500, WASHINGTON, DC, 20005, US

(21) Appl. No.: 10/875,680

(22) Filed: Jun. 25, 2004

(30) Foreign Application Priority Data
Jun. 26, 2003 (JP) JP2003-182205

(51) Int. Cl. G06K 15/02; H04N 1/387; H04N 1/393

(52) U.S. Cl. 358/1.18; 358/450; 358/451; 358/1.2

(57) ABSTRACT

A page processing apparatus for forming layout information showing an allocating position of each page for multi-page printing in which a plurality of pages are arranged to one print medium and printed has: a page designating unit which designates a page to be overlapped and an overlapping page among the pages; an area designating unit which designates an overlap possible area or an overlap inhibition area to an area of the designated page to be overlapped and obtains the designated area as area information; and a layout information obtaining unit which determines a layout position of each page on the basis of the obtained area information and obtains a predetermined page layout as layout information. A good print result is obtained in the multi-page printing.

### BACKGROUND OF THE INVENTION

1. Field of the Invention

The invention relates to a page processing method and a page processing apparatus for multi-page printing in which a plurality of pages are arranged onto one print medium and printed.

2. Related Background Art

For example, in printing of a screen which is displayed on a monitor, what is called, hard copy printing, a page processing apparatus in which a plurality of display screens to be printed are preliminarily designated and a layout is made so that the plurality of designated display screens are arranged at predetermined intervals has been disclosed in JP-A-5-313853.

A page processing apparatus in which a plurality of designated display screens are converted at a predetermined magnification and a layout is made so that the plurality of magnification-converted display screens are arranged at predetermined intervals has been disclosed in JP-A-11-212749.

However, according to the page processing apparatus disclosed in JP-A-5-313853, since the designated display screens are simply overlapped, there is a case where a desired sentence or image is hidden in the overlapped portion and such a situation becomes a problem.

According to the page processing apparatus disclosed in JP-A-11-212749, since the designated display screens (pages) are converted by various magnifications, there is a risk of occurrence of differences in the magnification conversion, it is difficult for the reader to read a print result in which the pages having the differences in the magnification conversion and such a situation becomes a problem.

### SUMMARY OF THE INVENTION

It is, therefore, an object of the invention to provide a page processing apparatus and a page processing method for obtaining a good print result in the multi-page printing in which a plurality of pages are arranged onto one print medium and printed.

According to the present invention, there is provided a page processing apparatus for preparing layout information in which an allocating position of each page is shown for multi-page printing, comprising:

a page designating unit which designates a page to be overlapped and an overlapping page among a plurality of pages;

an area designating unit which designates an overlap possible area or an overlap inhibition area to an area of the page (to be overlapped) designated by the page designating unit and obtains the designated area as area information; and

a layout information obtaining unit which determines a layout position of each of the pages on the basis of the obtained area information and obtains the determined layout position as layout information.

Further, In the layout information obtaining unit of the page processing apparatus, whether or not a concave portion exists on a side where the area of the page to be overlapped is overlapped is discriminated, when the concave portion exists, whether or not the overlapping page can be fitted into the concave portion is discriminated, and when it is determined that the overlapping page can be fitted, the layout position of each of the pages is determined so as to fit the overlapping page into the concave portion.

Further, in the page processing apparatus, the layout information obtaining unit converts the page to be overlapped and the overlapping page at a uniform magnification and, thereafter, determines the layout position of each of the pages.

Further, in the page processing apparatus, the area designating unit forms area information in which a weight has been added to the designated area, and the layout information obtaining unit determines the layout position of each of the pages in accordance with the weight on the basis of the area information showing the weighted area.

Further, the page processing apparatus may comprise an area information holding unit which holds the obtained area information.

Further, according to the present invention, there is also provided a page processing method of preparing layout information in which an allocating position of each page is shown for multi-page printing, comprising the steps of:

designating a page to be overlapped and an overlapping page among a plurality of pages;

designating an overlap possible area or an overlap inhibition area to an area of the designated page to be overlapped and obtaining the designated area as area information; and

determining a layout position of each of the pages on the basis of the obtained area information and obtaining the determined layout position as layout information.

In the page processing method, with respect to the layout position, whether or not a concave portion exists on a side where the area of the page to be overlapped is overlapped is discriminated, when the concave portion exists, whether or not the overlapping page can be fitted into the concave portion is discriminated, and when it is determined that the overlapping page can be fitted, the layout position of each of the pages is determined so as to fit the overlapping page into the concave portion.

Further, in the page processing method, with respect to the layout position, the page to be overlapped and the overlapping page are converted at a uniform magnification and, thereafter, the layout position of each of the pages is determined.

Further, in the page processing method, the area information is information in which a weight has been added to the designated area, and with respect to the layout position, the layout position of each of the pages is determined in accordance with the weight on the basis of the area information showing the weighted area.

Further, according to the present invention, there is also provided a page processing apparatus for preparing layout information in which an allocating position of each page is shown for multi-page printing in which a plurality of pages are arranged onto one print medium and printed, comprising:

a first area designating unit which designates an overlap inhibition area to each area of the plurality of pages and obtains the designated area as first area information;

a second area designating unit which designates a dividing area and/or an area to be divided to the dividable overlap inhibition area among the plurality of overlap inhibition areas and obtains the designated area as second area information; and

a layout information obtaining unit which determines a layout position of each of the plurality of pages on the basis of the obtained first area information and/or the second area information and obtains the determined layout position as layout information.

In the page processing apparatus, the second area designating unit converts the overlap inhibition areas at a uniform magnification and, thereafter, designates the dividing area and/or the area to be divided.

The above and other objects and features of the present invention will become apparent from the following detailed description and the appended claims with reference to the accompanying drawings.

### BRIEF DESCRIPTION OF THE DRAWINGS

FIG. 1 is a block diagram of a page processing apparatus of the invention;

FIG. 2 is a block diagram of a print system in which the page processing apparatus of the invention is assembled;

FIG. 3 is a setting flowchart for the print system;

FIG. 4 is a printing flowchart for the print system;

FIG. 5 is a diagram showing a display screen for obtaining area information;

FIG. 6 is an obtaining flowchart for the area information;

FIG. 7 is a flowchart for a page layout for obtaining layout information;

FIGS. 8A to 8F are diagrams showing basic layouts of a multi-page;

FIGS. 9A to 9F are diagrams showing a layout process of a 2-UP multi-page;

FIGS. 10A to 10D are diagrams showing a concave portion;

FIG. 11 is a block diagram showing an area designating unit in the embodiment 2;

FIG. 12 is a diagram showing a display screen for obtaining area information in the embodiment 2;

FIG. 13 is a flowchart showing a page layout process in the embodiment 2;

FIGS. 14A to 14D are diagrams showing a process for increasing areas which are overlapped step by step in accordance with a weight;

FIGS. 15A to 15D are explanatory diagrams showing a layout process in the embodiment 3; and

FIG. 16 is a flowchart for explaining processes of portions in the layout process in the embodiment 3 which are different from those in FIG. 4 in the embodiment 1.

### DETAILED DESCRIPTION OF THE PREFERRED EMBODIMENTS

Embodiments of the invention will now be described in detail hereinbelow with reference to the drawings.

### Embodiment 1

Each display screen which is displayed onto a monitor is referred to as each page. A page processing apparatus 10 of the invention obtains a layout position, as layout information, to which each page is allocated in order to print the pages in a lump (multi-page printing) onto a print medium having a predetermined print area.

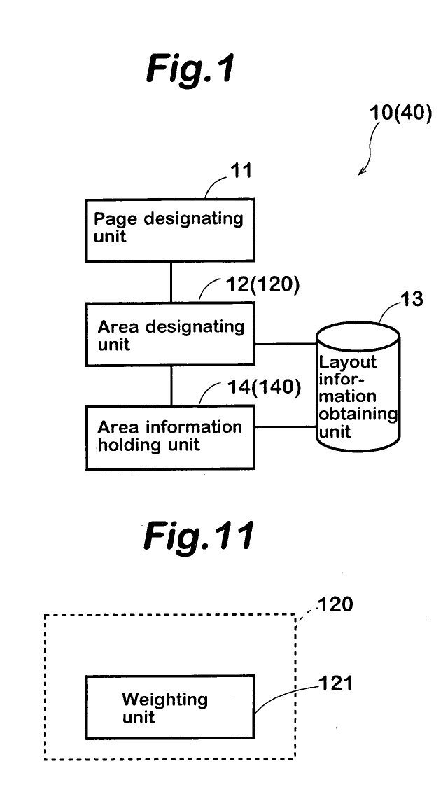

As shown in FIG. 1, the page processing apparatus 10 of the invention comprises: a page designating unit 11 which designates either a page to be overlapped or an overlapping page to a plurality of pages to be allocated; an area designating unit 12 which designates an overlap possible area or an overlap inhibition area to the area on the page (to be overlapped) designated by the page designating unit 11; an area information holding unit 13 which holds the area designated by the area designating unit 12 as area information; and a layout information obtaining unit 14 which decides the layout position of each page on the basis of the area information held in the area information holding unit 13 and obtains layout information showing the decided positional relation.

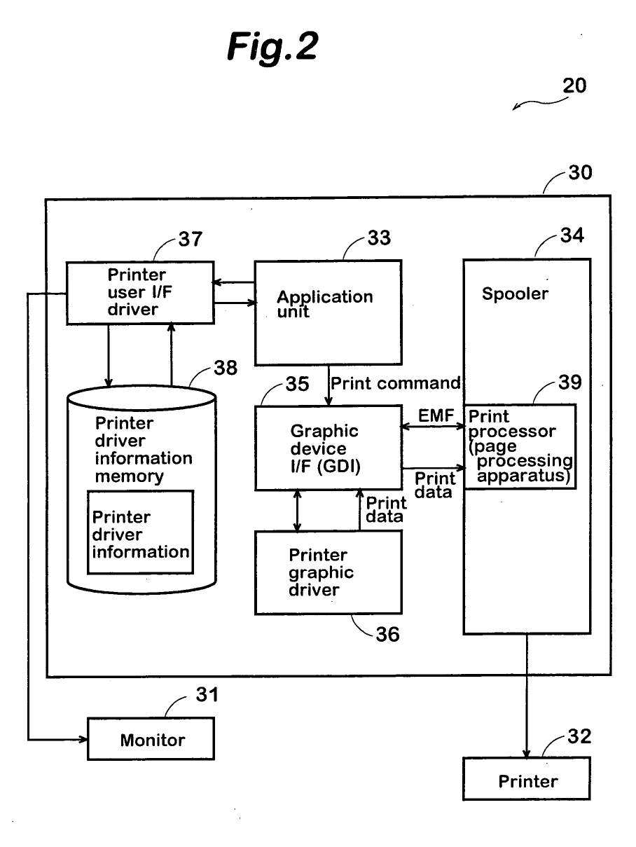

A print system 20 in which the page processing apparatus 10 of the invention is assembled will now be described. As shown in FIG. 2, the print system 20 comprises: an arithmetic operation processing apparatus 30; a monitor 31 connected to the arithmetic operation processing apparatus 30; and a printer 32 connected to the arithmetic operation processing apparatus 30.

The monitor 31 executes a display or the like regarding a GUI (Graphical User Interface) for operating a display screen such as window, icon, or the like by a pointing device such as a mouse or the like.

The arithmetic operation processing apparatus 30 comprises: an application unit 33 as application software for forming a document to be printed and printing it; a spooler 34 for managing a job which was print-requested from the application unit 33 by a queue; a graphic device interface (hereinafter, simply referred to as GDI) 35 for forming a print intermediate file in a data format which does not depend on a function of the printer 32, for example, a format called EMF (Enhanced Metafile format) in “Windows” (registered trademark: Microsoft Corporation); a printer graphic driver 36 for forming print data which depends on a function of an output device (printer 32) on the basis of data converted into a format which can process the EMF by the GDI 35; a printer user interface driver 37 which is used by the user to set a page size, a print orientation of a print medium, and the like by the GUI; and a printer driver information memory 38 for holding the information showing the page size and the print orientation of the print medium set by the user as printer driver information. The area information holding unit 13 of the page processing apparatus 10 of the invention is included in the printer driver information memory 38.

The spooler 34 has a print processor 39 for properly changing a format of the print job on the basis of the data format of the print job. The print processor 39 has the area designating unit 12 and the layout information obtaining unit 14 of the page processing apparatus 10 of the invention as a program, activates this program, and processes the EMF.

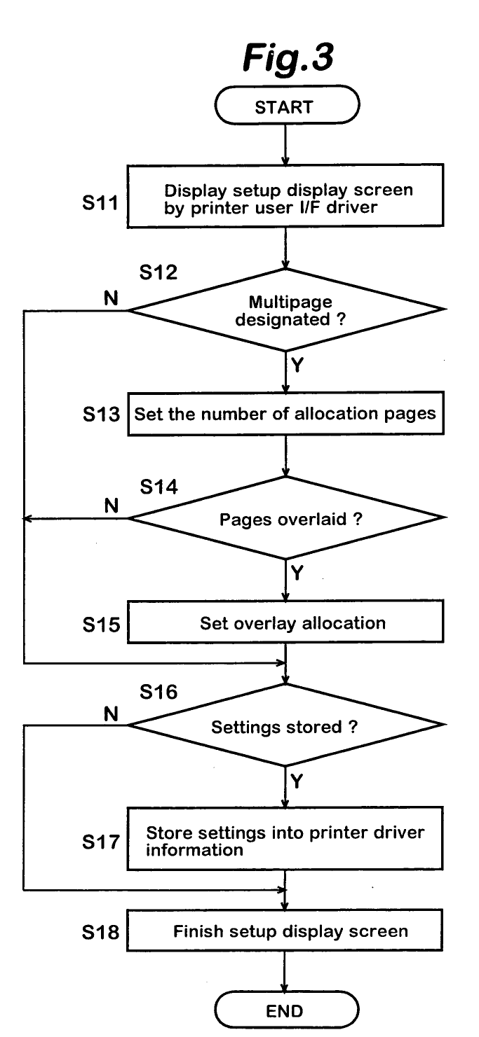

The operation of the print system 20 including the page processing apparatus 10 of the invention will now be described with reference to a flowchart of FIG. 3.

Prior to printing, print setting items are displayed onto the monitor 31 in order to make a predetermined setup by using the GUI (step S11).

The following items are shown in the displayed print setting items: for example, an item for setting whether multi-page printing is executed or normal printing is executed; an item for what is called an N-UP setting for setting whether two pages are printed in a lump onto one print medium (2-UP setting) or four pages are printed in a lump (4-UP setting); and the like.

The user discriminates whether the multi-page printing is executed or not (step S12).

When the multi-page printing is executed, the number of pages to be allocated to one print medium is set by the user (step S13).

Subsequently, the user discriminates whether the pages to be allocated are overlapped or not (step S14).

When the pages are overlapped and allocated, a setting showing such an operation is made (step S15).

The user discriminates whether the foregoing various set contents are held or not (step S16).

When the user determines that the various set contents are held and selects a “store” button which is displayed on the display screen, the set contents are held as printer driver information into the printer driver information memory 38 (step S17).

After that, the user closes the display screen on which the print setting items have been shown and finishes the setting process (step S18).

Prior to printing, the user makes various setups on the basis of the displayed print setting items, so that the set contents can be reflected to the print result.

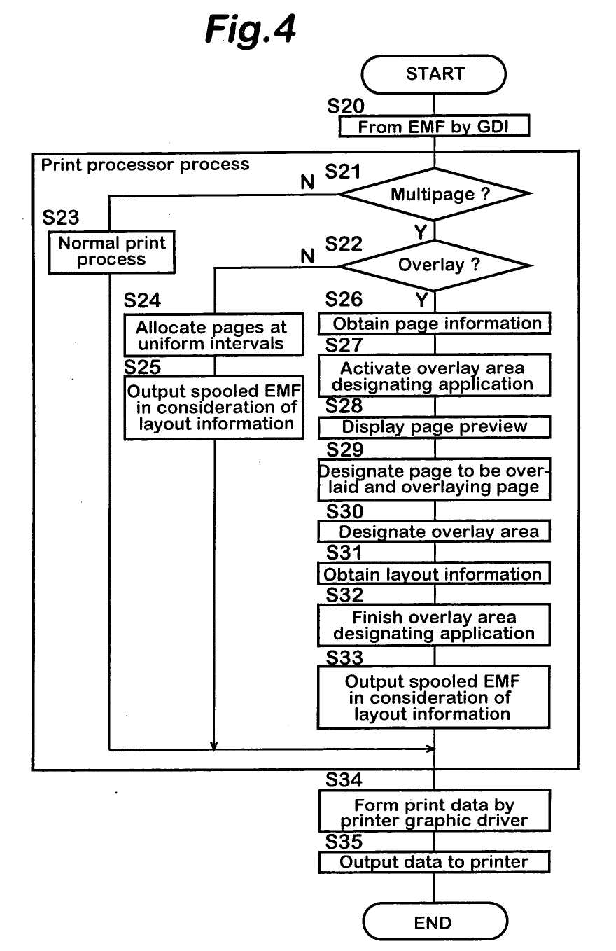

A printing process will now be described with reference to a flowchart of FIG. 4.

When the print function provided for the application unit 33 is activated, a print command is outputted from the application unit 33 to the GDI 35.

The GDI 35 which received the print command forms an EMF as a print intermediate file (step S20) on the basis of the document (pages) formed by the application unit 33 and outputs (spools) it to the spooler 34.

The spooler 34 which received the EMF accesses the printer driver information memory 38 shown in the EMF by the print processor 39 of the spooler 34 and obtains the printer driver information from the printer driver information memory 38. The print processor 39 discriminates whether or not the setting for performing the multi-page printing is shown in the obtained printer driver information (step S21).

The print processor 39 which determined that the setting for performing the multi-page printing has been made discriminates whether or not the setting for performing the overlap is shown in the obtained printer driver information (step S22).

If it is determined in step S21 that the execution of the multi-page printing is not set, in order to print one page onto one print medium, that is, to execute what is called the normal printing, the print processor 39 outputs the EMF spooled in the spooler 34 to the printer graphic driver 36 through the GDI 35 in order to convert it into a format which can be processed by the printer graphic driver 36 (step S23).

If it is determined in step S22 that the setting for overlapping and allocating the pages is not set, the print processor 39 allocates the properly enlarged or reduced pages at uniform intervals in accordance with the print area of the print medium on the basis of the N-UP information of the printer driver information and determines the page layout (step S24). The decided layout position is held as layout information into the printer driver information memory 38.

The print processor 39 outputs the EMF spooled in the spooler 34 to the printer graphic driver 36 through the GDI 35 in order to convert it into a format which can be processed by the printer graphic driver 36 in consideration of the layout information held in the printer driver information memory 38 (step S25).

If it is determined in step S21 that the execution of the multi-page printing has been set, on the basis of the printer driver information obtained from the printer driver information memory 38, the print processor 39 obtains the page size information showing an amount of document (pages) to be printed and the print orientation information showing the direction of the print medium as page information and forms a list of those information (step S26).

After that, the page processing apparatus 10 of the invention provided for the print processor 39 is activated as an application (step S27).

When the application is activated, each page to be printed is previewed onto the display screen of the monitor 31 on the basis of the page information shown on the list (step S28).

Subsequently, data to designate the page to be overlapped or the overlapping page for each of the above pages is sent to the page designating unit 11 of the page processing apparatus 10 by the user who referred to the preview display screen. On the basis of the data, the page designating unit 11 which received the data designates either the page to be overlapped or the overlapping page for each page (step S29).

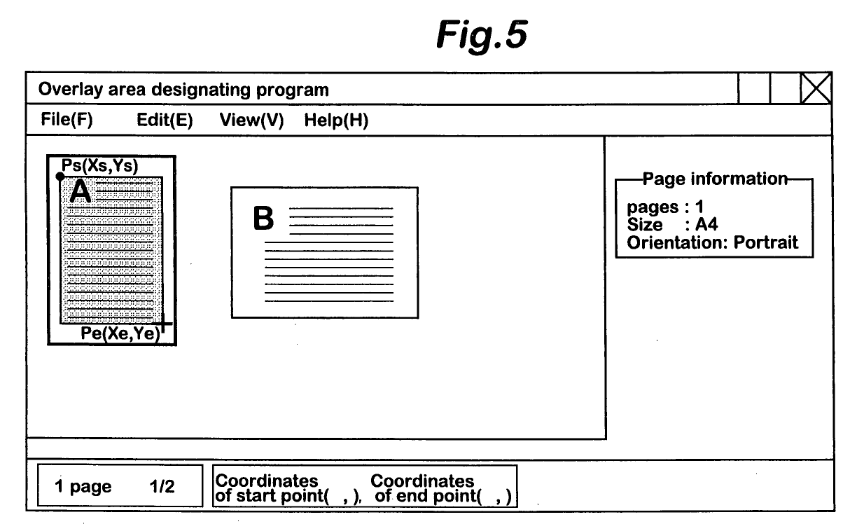

For example, the case where when there are two pages to be multi-page-printed, one of them becomes the page to be overlapped and the other becomes the overlapping page will now be described with reference to FIG. 5. The page to be overlapped is the left page shown by “A” and the overlapping page is the right page shown by “B”.

After that, in order to designate an overlap inhibition area by the user, data to designate the inhibition area is sent to the area designating unit 12 of the page processing apparatus 10. The area designating unit 12 designates either the area which can be overlapped to the area of the page to be overlapped or the overlap inhibition area on the basis of the obtained data and obtains the designated area as area information (step S30). The obtained area information is managed by coordinates and held by the area information holding unit 13.

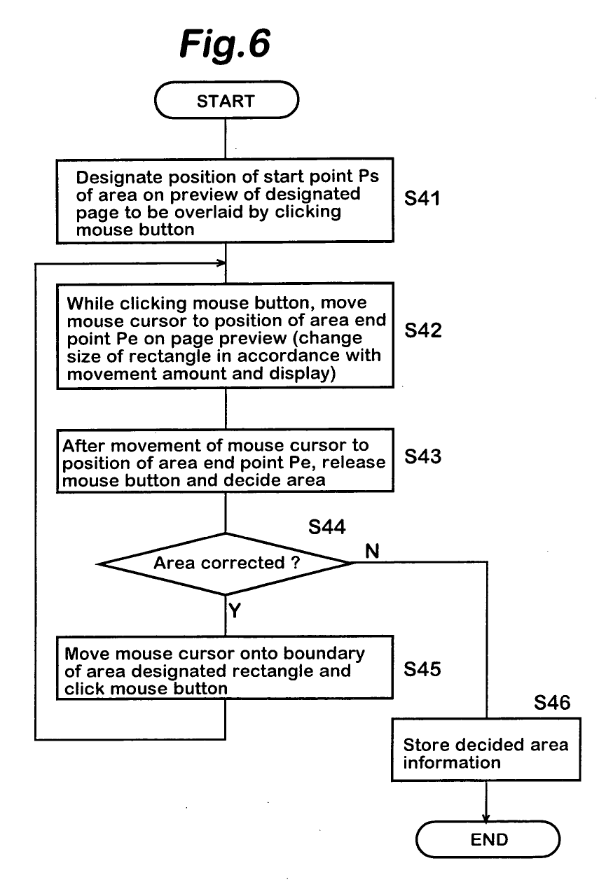

The process for obtaining the area information will now be described in detail with reference to the example of the display screen of FIG. 5 and a flowchart of FIG. 6.

On the preview display screen which displays the designated page to be overlapped, in order to designate the area which can be overlapped or the overlap inhibition area by using the pointing device such as a mouse or the like, the user presses a mouse button at a position (Ps) serving as a start point of the area. Thus, coordinate data of the start position of the area is transmitted to the area designating unit 12 (step S41).

With the mouse button pressed, the user moves a mouse cursor to a position (Pe) to be set to an end point of the area on the preview display screen (step S42). At this time, a changing rectangular area is displayed on the display screen in accordance with the mouse cursor which is moved.

After the user moved the mouse cursor to the position to be set to an end point, when he releases the pressed mouse button, coordinate data of the end position is transmitted to the area designating unit 12. Thus, the area designating unit 12 obtains the rectangular area surrounded by the start point and the diagonal end point as an area which can be overlapped or an overlap inhibition area (step S43).

The user discriminates whether or not the designated area is a desired range as necessary (step S44).

If it is determined that the designated area is not the desired range, the user moves the mouse pointer to a boundary of the rectangular area and presses the mouse button in order to again set the rectangular area (step S45). After that, the processes from step S42 mentioned above are executed.

If it is determined in step S44 that there is no need to correct the area designated by the user, in the designated area, the start point Ps and the end point Pe are held as area information in the area information holding unit 13 (step S46).

The foregoing Ps and Pe are coordinates in which a top left end is set to an origin on the preview page.

In the designation of the area, either the overlapping area or the overlap inhibition area is designated. In the embodiment, however, the overlap inhibition area is designated as an area and the following processes will be described on the basis of the area information showing such an area.

Returning to the flowchart of FIG. 4, the layout information obtaining unit 14 of the page processing apparatus 10 determines the layout position of each page on the basis of the area information held in the area information holding unit 13 and obtains the layout information showing the determined positional relation (step S31).

After the obtainment of the layout information, the application activated as a page processing apparatus 10 is finished (step S32).

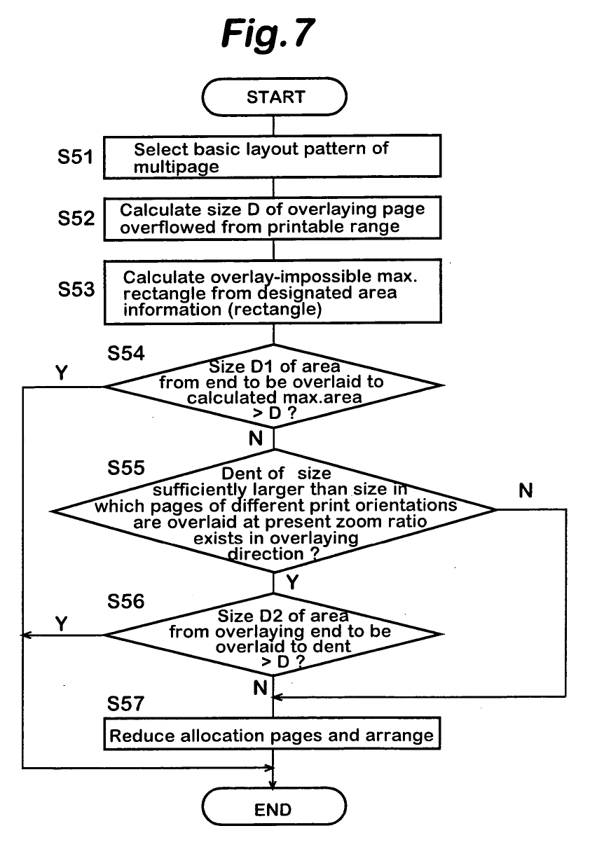

The obtainment of the layout information will now be described in detail with reference to FIGS. 7, 8A to 8F, 9A to 9F, and 10A to 10D.

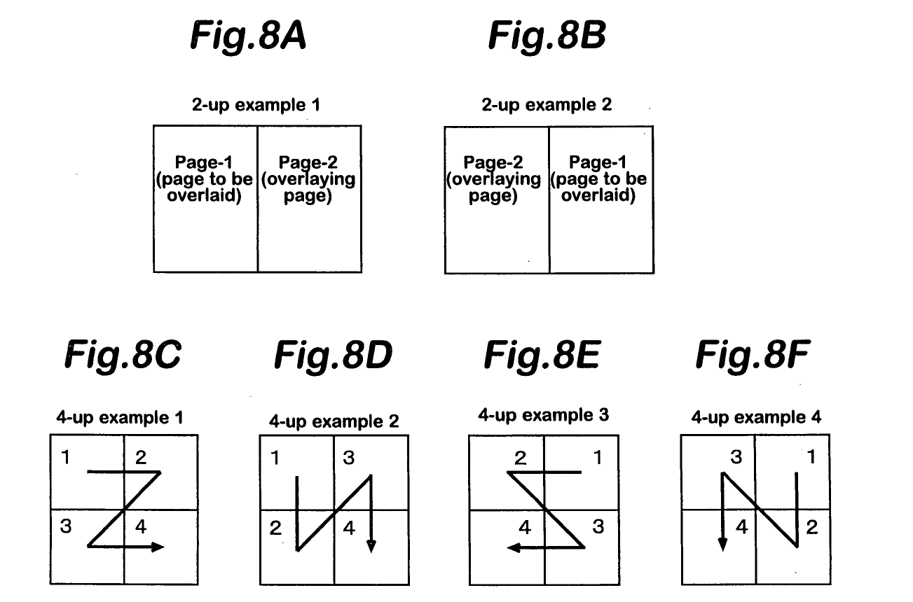

The layout information obtaining unit 14 of the page processing apparatus 10 preview-displays the basic layout corresponding to N-UP set by the user with reference to the printer driver information held in the printer driver information memory 38. As basic layouts, as shown in FIGS. 8A to 8F, for example, if 2-UP has been set, a layout in which the respective pages are allocated to the left and right as shown in FIGS. 8A and 8B is displayed. If 4-UP has been set, the following layout is displayed: the pages are allocated in order of upper left, upper right, lower left, and lower right positions of 4-split areas in FIG. 8C; the pages are allocated in order of upper left, lower left, upper right, and lower right positions of the 4-split areas in FIG. 8D; the pages are allocated in order of upper right, upper left, lower right, and lower left positions of the 4-split areas in FIG. 8E; and the pages are allocated in order of upper right, lower right, upper left, and lower left positions of the 4-split areas in FIG. 8F.

The user selects a desired layout pattern from the previewed basic layout patterns (step S51).

Subsequently, the layout information obtaining unit 14 calculates a size D of overflowed area so as to overlap the overlapping page onto the page (to be overlapped) designated by the page designating unit 11 in accordance with the selected basic layout (step S52).

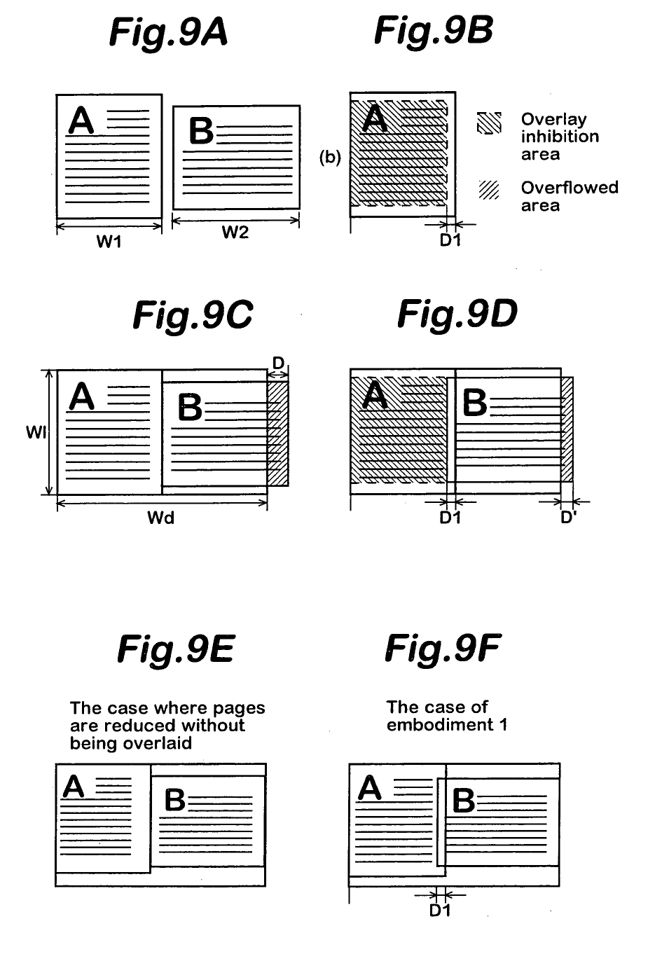

For example, as shown in FIG. 9A, when the right page shown by “B” as an overlapping page is overlapped to the right end of the left page shown by “A” as a page to be overlapped, as shown in FIG. 9C, a lateral width dimension “D” (overflow dimension) of the overflowed rectangular area of the right page from the print medium having a lateral width dimension Wd and a longitudinal dimension W1 is calculated by using the equation 1.

D=(W1+W2)*(zoom ratio)−Wd (1)

where,

W1: lateral width dimension of the left page

W2: lateral width dimension of the right page

Wd: lateral width dimension of the print medium

The zoom ratio (enlargement/reduction ratio) is set to about 0.7 in, for example, 2-UP and properly changed in accordance with the longitudinal and lateral length dimensions of the printable range.

Subsequently, on the basis of the area information held in the area information holding unit 13, the layout information obtaining unit 14 calculates a maximum rectangle as an overlap inhibition area as shown in FIG. 9B (step S53).

After that, in FIG. 9B, a margin dimension D1 of the overlapping page is calculated by using the following equation (2) and whether or not the calculated margin dimension D1 is larger than the overflow dimension D is discriminated by the layout information obtaining unit 14 (step S54).

D1=W1−Xe (2)

where,

Xe: X coordinate of the end point in the overlap inhibition area

When the margin dimension D1 is larger than the overflow dimension D, the layout information obtaining unit 14 allocates each page to be allocated without reducing. That is, as shown in FIG. 9F, the layout information obtaining unit 14 allocates the designated right page to the overlapping page so that it is not overlapped to the overlap inhibition area of the left page designated as a page to be overlapped. In detail, each page is allocated without changing the reduction ratio so that the left end of the margin area shown by the margin dimension (D1) of the left page and the left end of the right page are aligned.

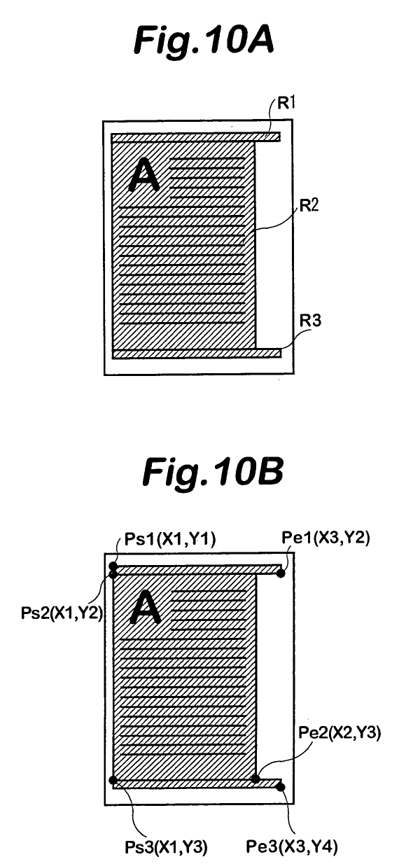

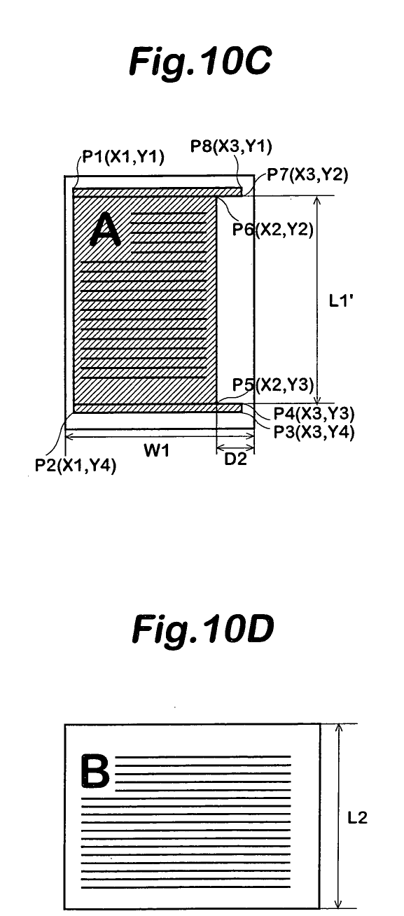

When the margin dimension D1 is smaller than the overflow dimension D, if the layout information obtaining unit 14 allocates the right page so that it is not overlapped to the overlap inhibition area of the left page, the right page overflows by a dimension shown by D′ as shown in FIG. 9D. In such a case, the layout information obtaining unit 14 discriminates whether or not a concave portion exists at the right end of the left page as shown in FIG. 10A. If the concave portion exists, the layout information obtaining unit 14 discriminates whether or not the left end of the right page can be fitted into the concave portion (step S55).

In this discrimination, when no concave portion exists in the left page or when the right page cannot be fitted even if the concave portion exists in the left page, the layout information obtaining unit 14 performs a magnification conversion to the left and right pages in accordance with the dimensions of the print medium and allocates them as shown in FIG. 9E (step S57).

Although an example in which the right page is not overlapped to the left page whose magnification has been reduced is shown in FIG. 9E, the allocation can be properly changed so as to overlap the right page to the left page whose magnification has been reduced.

When the right page can be fitted, on the other hand, whether or not a dent dimension D2 of the concave portion shown in FIG. 10C is larger than the overflow dimension D is discriminated by the layout information obtaining unit 14 (step S56).

When the dent dimension D2 is larger than the overflow dimension D, the layout information obtaining unit 14 allocates the right page so as to be fitted into the concave portion.

When the dent dimension D2 is smaller than the overflow dimension D, the layout information obtaining unit 14 performs the magnification conversion to the left and right pages in accordance with the dimensions of the print medium and allocates them (step S57).

Processes of the layout information obtaining unit 14 regarding the concave portion will now be described further in detail.

As shown in FIG. 10A, the concave portion is the dent in the overlap inhibition area in the overlapping page. That is, when the overlap inhibition area is divided into three areas of a rectangular area R1, a rectangular area R2, and a rectangular area R3, the rectangular area R1 and the rectangular area R3 which are longer than a width dimension of the rectangular area R2 are adjacent to the rectangular area R2.

Each rectangular area has a start point and an end point. As shown in FIG. 10B, assuming that the upper left position is set to an origin, the rectangular area R1 is shown by the start point Ps1 (X1, Y1) and the end point Pe1 (X3, Y2), the rectangular area R2 is shown by the start point Ps2 (X1, Y2) and the end point Pe2 (X2, Y3), and the rectangular area R3 is shown by the start point Ps3 (X1, Y3) and the end point Pe3 (X3, Y4), respectively. Therefore, as shown in FIG. 10C, each angle of the overlap inhibition area mentioned above can be shown by the following coordinates in counterclockwise order from the upper left position: coordinates P1 (X1, Y2); coordinates P2 (X1, Y4); coordinates P3 (X3, Y4); coordinates P4 (X3, Y3); coordinates P5 (X2, Y3); coordinates P6 (X2, Y2); coordinates P7 (X3, Y2); and coordinates P8 (X3, Y1).

In the above coordinates, the respective coordinates are verified in order of, for example, the coordinates P1, the coordinates P2, the coordinates P3, the coordinates P4, the coordinates P5, the coordinates P6, the coordinates P7, and the coordinates P8. If there are the following relations: after the value of the Y coordinate increased, the value of the X coordinate increases; after the value of the X coordinate increased, the value of the Y coordinate decreases; after the value of the Y coordinate decreased, the value of the X coordinate decreases; and after the value of the X coordinate decreased, the value of the Y coordinate decreases, an internal angle of the overlap inhibition area constructed by a plurality of rectangular areas is equal to 90°. When it is not equal to 90°, it is equal to 270°. The coordinates in which the internal angle is equal to 270° are P5 and P6 as shown in FIG. 10C. Assuming that a line connecting P5 and P6 is a bottom side of the concave portion, a length dimension L1′ of the bottom side can be calculated by subtracting the value of the Y coordinate of P5 from the value of the Y coordinate of P6 as shown by the following equation (3).

L1′=Y3−Y2 (3)

At which one of the upper, lower, right, and left ends of the overlap inhibition area the position of the concave portion in the overlap inhibition area is provided can be determined on the basis of the coordinates of P4which is one-precedent to the coordinates P5 and the coordinates of P7 which is one-subsequent to the coordinates P6. In the embodiment, it will be understood that since both of the X coordinate “X3” of P4 and the X coordinate “X3” of P7 are larger than the X coordinate “X2” of P5 and the X coordinate “X2” of P6, the concave portion is provided at the right end of the overlap inhibition area.

In the embodiment, in order to discriminate whether or not the right page designated as an overlapping page can be fitted into the concave portion of the left page designated as a page to be overlapped, a length dimension L2 of the overlapping page shown in FIG. 10D is compared with the length dimension L1′ of the bottom side of the concave portion. Thus, when the length dimension shown by L1′ is longer than the length dimension shown by L2, the right page is shifted by a distance corresponding to the dimensions shown by D2 in FIG. 10C so as to fit the right page into the concave portion. At this time, since D2 indicates a distance from the lateral width dimension of the left page to the bottom side of the concave portion, it is expressed by the following equation (4).

D2=W1−X2 (4)

Returning to step S32 in the flowchart of FIG. 4, the page layout determined by the foregoing processes is held as layout information into the printer driver information memory 38.

The print processor 39 outputs the EMF spooled in the spooler 34 to the printer graphic driver 36 through the GDI 35 in order to convert it into the format which can be processed by the printer graphic driver 36 in consideration of the layout information held in the printer driver information memory 38 (step S33).

The printer graphic driver 36 which obtained the data converts it into print data which depends on the function of the printer 32 (step S35).

The print data is outputted from the printer graphic driver 36 to the printer 32 through the GDI 35 and the spooler 34.

The printer 32 which obtained the print data executes the printing on the basis of the data (step S36).

As mentioned above, according to the page processing apparatus 10 of the invention for obtaining the layout information for the multi-page printing, the area including the desired sentence or image is designated as an overlap inhibition area and overlapped to the area other than the overlap inhibition area. Therefore, the page layout can be made without hiding the desired sentence or image. The page to be arranged can be allocated without providing a magnification difference.

### Embodiment 2

A page processing apparatus 40 in which an area designated by an area designating unit 120 is weighted and a page layout is made in accordance with the weight will now be described.

As shown in FIG. 1, the page processing apparatus 40 of the embodiment 2 comprises: the page designating unit 11; the area designating unit 120; a layout information obtaining unit 140; and the area information holding unit 13.

As shown in FIG. 11, the area designating unit 120 of the embodiment 2 has a weighting unit 121. The weighting unit 121 adds a weight to the designated area by a natural number.

The layout information obtaining unit 140 of the embodiment 2 makes a page layout in consideration of the weight added by the weighting unit 121.

The operation of the area designating unit 120 will now be described with reference to the drawings. The area designating unit 120 of the embodiment 2 adds the weight to the area designated in step S43 in the flowchart of FIG. 6 used for explaining the operation of the area designating unit 12 in the embodiment 1 mentioned above.

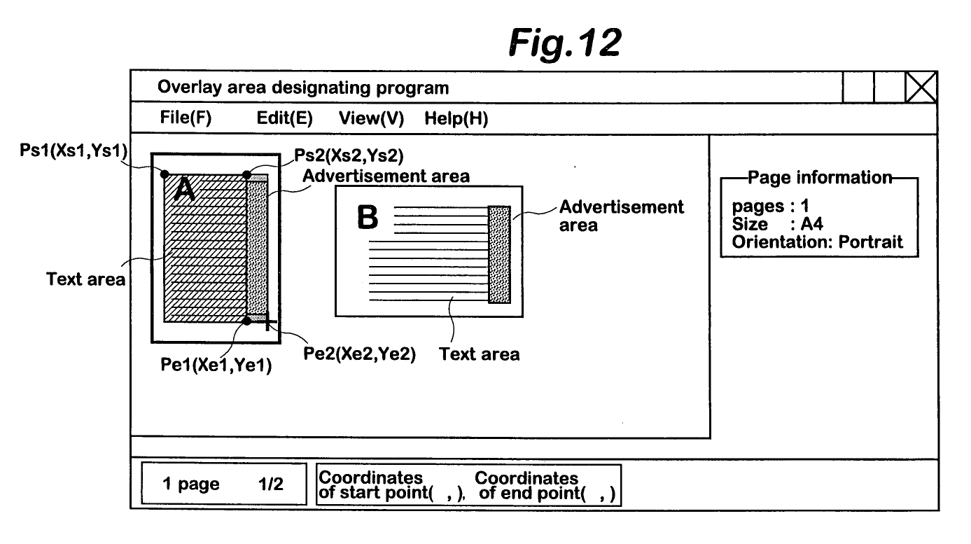

The operation will now be explained with respect to the case of multi-page-printing, for example, a display screen of a Web page. As shown in FIG. 12, the left page designated as a page to be overlapped is constructed by a text area shown by “A” and an advertisement area at the right end. The right page designated as an overlapping page is constructed by a text area shown by “B” and an advertisement area at the right end. When the user wants to see the text areas, a significance of the advertisement area is lower than that of the text area and a weight is added to the area in accordance with the significance rated by the user himself.

At this time, for example, by displaying each area of the page to be previewed in dark color in accordance with an increase in weight value of such an area, the user can easily grasp the weighting state of each area weighted by himself.

For example, although the interruption inhibition area has been designated in only one position in the embodiment 1 mentioned above, since the area is weighted in the embodiment 2, a plurality of interruption inhibition areas are designated. However, there is also a case where the area of a small weight is overlapped as necessary by a process, which will be explained hereinafter.

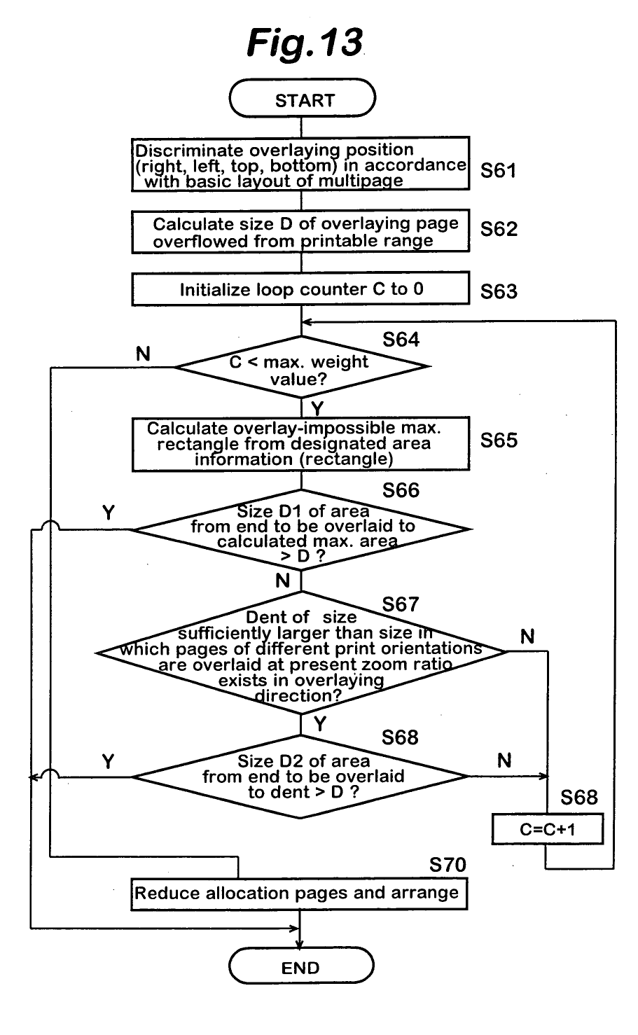

The operation of the layout information obtaining unit 140 of the embodiment 2 will now be described with reference to a flowchart of FIG. 13. The printer driver information held in the printer driver information memory 38 is referred to and the basic layout corresponding to N-UP set by the user is preview-displayed. At this time, by displaying each area of the page to be previewed in the dark color in accordance with an increase in weight value of such an area, the user can grasp the weight added to each area of the page.

The user selects a desired layout from the previewed basic layout patterns (step S61).

Subsequently, the size D of the overflowed area is calculated by the layout information obtaining unit 140 so as to overlap the overlapping page to the page (to be overlapped) designated by the page designating unit 11 in accordance with the selected basic layout (step S62).

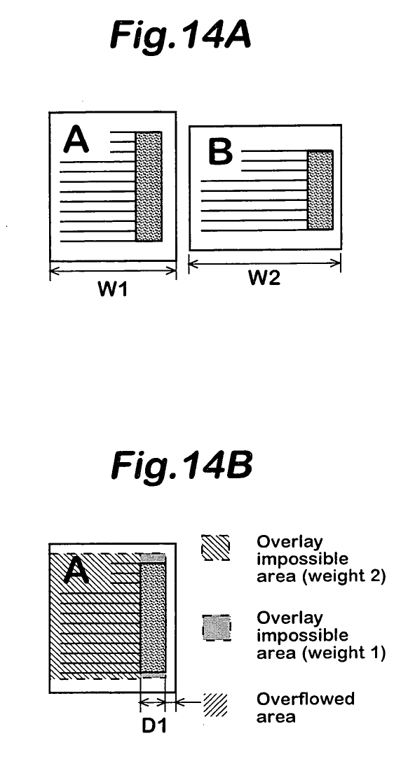

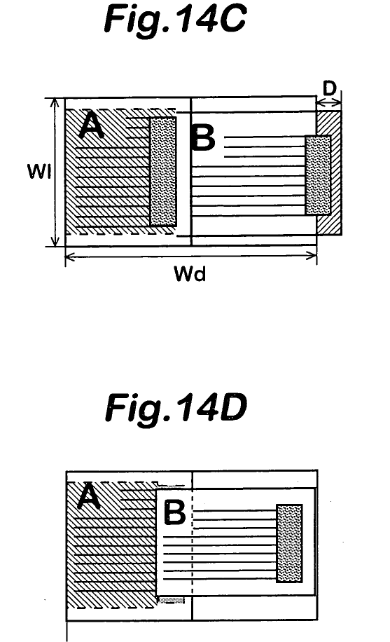

For example, as shown in FIG. 14A, when the right page shown by “B” as an overlapping page is overlapped to the right end of the left page shown by “A” as a page to be overlapped, the lateral width dimension D (overflow dimension) of the overflowed rectangular area from the print medium having the lateral width dimension Wd and the longitudinal dimension W1 on the right page is calculated by the layout information obtaining unit 140 by using the equation (1) as shown in FIG. 14C.

After the overflow dimension is calculated, the layout information obtaining unit 140 initializes a counter value to “0” (step S63).

Subsequently, the counter value incremented by repeating processes of steps S65 to S69, which will be explained hereinafter, is compared with the maximum weight value (step S64).

At this time, when the counter value is equal to or larger than maximum weight value, the layout information obtaining unit 140 performs the magnification conversion to the left and right pages at a uniform magnitude in accordance with the dimensions of the print medium and allocates them (step S70).

When the counter value is less than the maximum weight value, in order to calculate the area to be overlapped, first, the layout information obtaining unit 140 uses the area weighted by the value larger than the counter value as an overlap inhibition area on the basis of the area information held in the area information holding unit 13, searches for the maximum coordinate values and the minimum coordinate values of such an area, and calculates the maximum rectangular area as such an overlap inhibition area as shown in FIG. 14B (step S65).

After that, in FIG. 14B, the layout information obtaining unit 140 calculates the margin dimension D1 of the overlapping page by using the equation (2) and discriminates whether or not the calculated margin dimension D1 is larger than the overflow dimension D (step S66).

When the margin dimension D1 is larger than the overflow dimension D, the layout information obtaining unit 140 allocates each page to be allocated without reducing them. That is, as shown in FIGS. 14C and 14D, the right page designated as an overlapping page is allocated while shifting it step by step so that it is not overlapped to the overlap inhibition area of the left page designated as a page to be overlapped. That is, when the page cannot be allocated by predetermined dimensions of the print medium, the layout information obtaining unit 140 allocates the page so that the left end of the right page is aligned to the right end of the area of the small weight such as an advertisement area or the like of the left page.

By adding the weight according to the significance of the page to be allocated to each area of the page, when the allocation is performed, the areas can be allocated in order of the area of the small significance. Therefore, the user can make the page layout in the area of the large significance.

On the other hand, when the margin dimension D1 is smaller than the overflow dimension D, as shown in FIG. 14C, if the right page is allocated so as not to be overlapped to the overlap inhibition area of the left page, the right page overflows by the area corresponding to the dimension shown by D. In such a case, as shown in FIG. 10A, the layout information obtaining unit 140 discriminates whether or not a concave portion exists at the right end of the left page. If the concave portion exists, the layout information obtaining unit 140 discriminates whether or not the left end of the right page can be fitted into the concave portion (step S67).

In this discrimination, when there is no concave portion in the left page or when the right page cannot be fitted even if the concave portion exists in the left page, the layout information obtaining unit 140 increments the counter value (step S69) and executes the processes from step S64 mentioned above.

If the right page can be fitted, whether or not the dent dimension D2 of the concave portion shown in FIG. 10C is larger than the overflow dimension D is discriminated (step S68).

If the dent dimension D2 is larger than the overflow dimension D, the layout information obtaining unit 140 allocates the right page so as to be fitted into the concave portion.

When the dent dimension D2 is smaller than the overflow dimension D, the layout information obtaining unit 140 increments the counter value (step S69) and executes processes from step S64 mentioned above.

According to the page processing apparatus 40 of the embodiment 2, the user adds the weight according to the significance to each area constructing the page, so that he can make the allocation in which the areas have been overlapped in order of the area of the small weight. Therefore, the desired significance of the user can be reflected to the page layout.

In the foregoing embodiment, first, the page to be overlapped and the overlapping page are designated for each page to be allocated by the page designating unit 11. Subsequently, the enlargement or reduction is made to the page to be overlapped and the overlapping page as necessary and the page layout is made by the layout information obtaining unit 14. However, it is also possible to construct the apparatus in such a manner that the operation for obtaining the value of the conversion magnification to execute the enlargement or reduction in order to make the page layout under the conditions in which the page to be overlapped and the overlapping page have arbitrarily been designated is executed with respect to all combinations, and the page to be overlapped and the overlapping page are designated for each page so that the value of the conversion magnification becomes the maximum.

In the foregoing embodiment, the overlap inhibition area is designated by the area designating unit 12 and the page layout is made so that the area is not overlapped to the designated overlap inhibition area. However, it is also possible to designate the overlap possible area by the area designating unit 12 and make a page layout so that the area is overlapped within the designated overlap possible area.

### Embodiment 3

In this embodiment, a modification of a layout process which is suitable in the case where areas of a plurality of page overlap inhibition areas to be multi-page-printed are largely different will be explained.

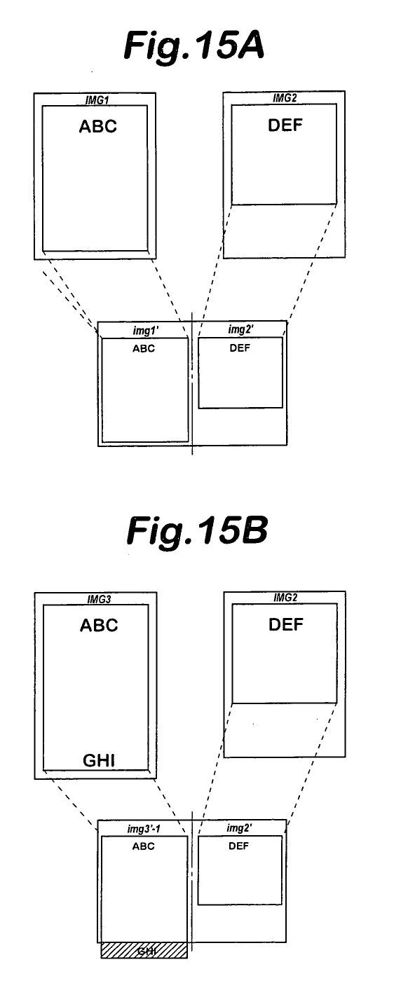

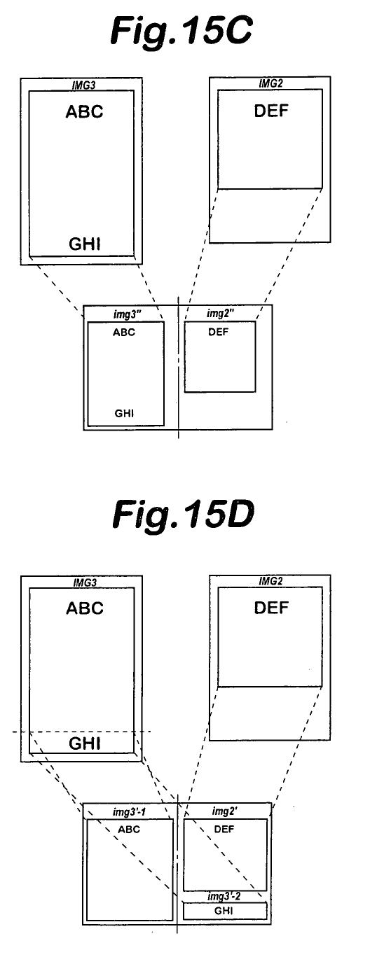

FIGS. 15A to 15D are explanatory diagrams showing the layout process in the embodiment 3.

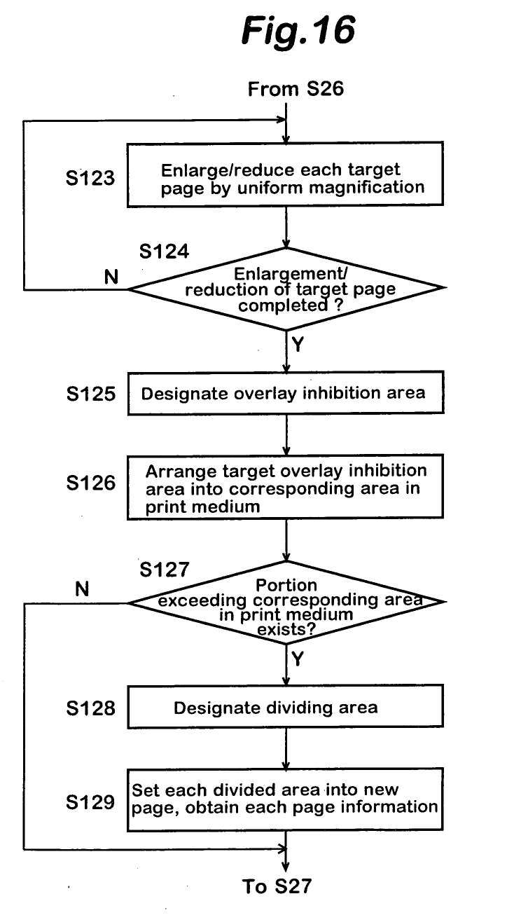

FIG. 16 is a flowchart for explaining processes of portions different from those in FIG. 4 in the embodiment 1 in the layout process in the embodiment 3.

The embodiment 3 will now be described hereinbelow with reference to FIGS. 15A to 15D and 16.

Two outside rectangles shown at the upper stage of each of FIGS. 15A to 15D show areas corresponding to the print media. IMG1, IMG2, and IMG3 as inside rectangles show overlap inhibition areas in the page data prior to executing the layout process. IMG1 and IMG2 indicate the overlap inhibition areas in the page data formed by the application program by presuming that the pages are printed onto a print medium of a letter size (W×H=8.5×11 inches). IMG3 indicates the overlap inhibition area in the page data formed by the application program by presuming that the pages are printed onto a print medium of a legal-13 size (W×H=8.5×13 inches).

An outside rectangle shown at the lower stage of each of FIGS. 15A to 15D shows an area corresponding to the print medium to be reduction-printed. In FIGS. 15A to 15D, the print medium has the legal-13 size (W×H=8.5×13 inches). Inside rectangles show areas in which the areas IMG1, IMG2, and IMG3 are reduced, respectively.

In FIG. 15A, since the original page data IMG1 and IMG2 has been formed on the assumption that the pages are printed onto the print medium of the letter size, respectively, if they are arranged so that the portions in the lateral direction of areas img1′ and img2′ reduced at the same ratio are not overlapped, they are just enclosed in the print medium of the legal-13 size.

In FIG. 15B, since the original page data IMG3 has been formed on the assumption that the pages are printed onto the print medium of the legal-13 size and the original page data IMG2 has been formed on the assumption that the pages are printed onto the print medium of the letter size, respectively, if they are arranged so that the portions in the lateral direction of areas img3′ and img2′ reduced at the same ratio are not overlapped in a manner similar to FIG. 15A, a lower portion (a hatched area where a character string “GHI” is drawn) of the area img3′ overflows from the print medium of the legal-13 size.

In FIG. 15C, the procedure in the embodiment 1 is taken and the area img3′ in FIG. 15B is further reduced in the longitudinal direction so as to be enclosed in the print medium of the legal-13 size and areas img3″ and img2″ are allocated.

FIG. 15D shows an example of the layout process in the embodiment 3. The original page data IMG3 is divided into a first area where a character string “ABC” is drawn and a second area where the character string “GHI” is drawn and those areas are allocated as img3′-1 and img3′-2.

A procedure for allocating the areas will now be described with reference to the flowchart shown in FIG. 16. Processing steps S26 and S27 shown in FIG. 16 are the same as those shown in the flowchart of FIG. 4. The flowchart of FIG. 16 shows processes added between steps S26 and S27.

After page information (information of IMG1 and IMG2 or IMG3 in FIGS. 15A to 15D) is obtained in step S26 in FIG. 4, step S123 follows.

(Step S123)

Each page data as an allocation target is enlarged or reduced at a uniform magnification. This step corresponds to FIG. 15B.

(Step S124)

Whether or not the enlargement/reduction of all page data as allocation targets has been finished is discriminated. If it is determined that it has been finished (YES), step S125 follows. If it is not finished (NO), the processing routine is returned to step S123 and the enlarging/reducing process is repeated.

(Step S125)

The overlap inhibition areas are designated and step S126 follows (a process similar to step S30 in FIG. 4).

(Step S126)

The target overlap inhibition areas (corresponding to img1′ and img2′ in FIG. 15A and img3′ and img2′ in FIG. 15B, respectively) are arranged into the area corresponding to the print medium. Step S127 follows.

(Step S127)

Whether or not a portion in which the target overlap inhibition areas arranged in step S126 exceed the area corresponding to the print medium exists is discriminated.

If it is determined that the portion where they exceed such a corresponding area does not exist (corresponding to FIG. 15A), the processing routine advances to step S27 in FIG. 4.

If it is determined that the portion where they exceed such a corresponding area exists (corresponding to FIG. 15B), the processing routine advances to step S128.

(Step S128)

The overlap inhibition area (img3′ in FIG. 15B) where the portion exceeding the area corresponding to the print medium exists is divided into the areas (img3′-1 and img3′-2 in FIG. 15D) and each area is set.

(Step S129)

Each of the divided area is set to a new page, the page information of each page is obtained, and the processing routine advances to step S27 in FIG. 4.

The layout information is obtained and the print data is formed and outputted hereinbelow in a manner similar to the embodiment 1.

As described above, the layout information is obtained by uniformly enlarging or reducing the areas on the basis of the obtained first page information serving as an allocation target. When the arranged overlapping area exceeds the area of the print medium, the original page is divided, the second page information is obtained, and the layout information is obtained again. Therefore, there is no need to reduce the target page more than it is needed and the print result which does not lose the visibility is obtained.

According to the page processing apparatus of the invention, the page to be overlapped and the overlapping page are designated for each page to be allocated, the overlap possible area or the overlap inhibition area is designated to the area of the page to be overlapped, and the layout position of each page is determined on the basis of the designated area. Therefore, the page layout can be made without hiding the desired sentence or image and the pages can be allocated without providing a magnification difference to the page to be arranged. Consequently, the good print result in the multi-page printing can be obtained.

The present invention is not limited to the foregoing embodiments but many modifications and variations are possible within the spirit and scope of the appended claims of the invention.

What is claimed is:

1. A page processing apparatus for preparing layout information in which an allocating position of each page is shown for multi-page printing, comprising:
a page designating unit which designates a page to be overlapped and an overlapping page among a plurality of pages;
an area designating unit which designates an overlap possible area or an overlap inhibition area to an area of said page (to be overlapped) designated by said page designating unit and obtains the designated area as area information; and
a layout information obtaining unit which determines a layout position of each of said pages on the basis of said obtained area information and obtains the determined layout position as layout information.

2. The page processing apparatus according to claim 1, wherein in said layout information obtaining unit, whether or not a concave portion exists on a side where the area of said page to be overlapped is overlapped is discriminated, when the concave portion exists, whether or not said overlapping page can be fitted into said concave portion is discriminated, and when it is determined that said overlapping page can be fitted, the layout position of each of said pages is determined so as to fit said overlapping page into said concave portion.

3. The page processing apparatus according to claim 1, wherein said layout information obtaining unit converts said page to be overlapped and said overlapping page at a uniform magnification and, thereafter, determines the layout position of each of said pages.

4. The page processing apparatus according to claim 1, wherein
said area designating unit forms area information in which a weight has been added to the designated area, and
said layout information obtaining unit determines the layout position of each of said pages in accordance with the weight on the basis of the area information showing the weighted area.

5. The page processing apparatus according to claim 1, further comprising an area information holding unit which holds said obtained area information.

6. A page processing method of preparing layout information in which an allocating position of each page is shown for multi-page printing, comprising the steps of:
designating a page to be overlapped and an overlapping page among a plurality of pages;
designating an overlap possible area or an overlap inhibition area to an area of said designated page to be overlapped and obtaining the designated area as area information; and
determining a layout position of each of said pages on the basis of said obtained area information and obtaining the determined layout position as layout information.

7. The page processing method according to claim 6, wherein with respect to said layout position, whether or not a concave portion exists on a side where the area of said page to be overlapped is overlapped is discriminated, when the concave portion exists, whether or not said overlapping page can be fitted into said concave portion is discriminated, and when it is determined that said overlapping page can be fitted, the layout position of each of said pages is determined so as to fit said overlapping page into said concave portion.

8. The page processing method according to claim 6, wherein with respect to said layout position, said page to be overlapped and said overlapping page are converted at a uniform magnification and, thereafter, the layout position of each of said pages is determined.

9. The page processing method according to claim 6, wherein
said area information is information in which a weight has been added to said designated area, and
with respect to said layout position, the layout position of each of said pages is determined in accordance with the weight on the basis of the area information showing the weighted area.

10. A page processing apparatus for preparing layout information in which an allocating position of each page is shown for multi-page printing in which a plurality of pages are arranged onto one print medium and printed, comprising:
a first area designating unit which designates an overlap inhibition area to each area of said plurality of pages and obtains the designated area as first area information;
a second area designating unit which designates a dividing area and/or an area to be divided to the dividable overlap inhibition area among said plurality of overlap inhibition areas and obtains the designated area as second area information; and
a layout information obtaining unit which determines a layout position of each of said plurality of pages on the basis of said obtained first area information and/or said second area information and obtains the determined layout position as layout information.

11. The page processing apparatus according to claim 10, wherein said second area designating unit converts said overlap inhibition areas at a uniform magnification and, thereafter, designates the dividing area and/or the area to be divided.
